(19) United States
(12) Patent Application Publication
(10) Pub. No.: US 2019/0037798 A1
(43) Pub. Date: Feb. 7, 2019

(54) Apparatus for Raising Hatchlings Including a Paper Strip

(71) Applicant: Andrew Maendel, Starbuck (CA)

(72) Inventor: Andrew Maendel, Starbuck (CA)

(21) Appl. No.: 15/956,130

(22) Filed: Apr. 18, 2018

Related U.S. Application Data
(63) Continuation-in-part of application No. 15/201,562, filed on Jul. 4, 2016.

(51) Int. Cl. A01K 1/015; A01K 31/18; A01K 39/04; B31F 1/07; D21H 27/00; D21H 21/28; D21H 19/36

(52) U.S. Cl. CPC A01K 1/0157; A01K 31/18; A01K 39/04; B31F 2201/0715; D21H 27/00; D21H 21/28; D21H 19/36; B31F 1/07

(57) ABSTRACT

In an apparatus for raising chickens from hatchlings including a barn having a floor and walls there is provided a plurality of rows of feed stations arranged at spaced positions across the floor each with a feed supply line connected along the row for dispensing feed to each of the feed stations and a plurality of rows of water supply stations each with a water supply line connected along the row for dispensing water to each of the water supply stations where rows of stations are connected to a lift system for raising the stations from the floor. A first strip of biodegradable paper sheet is unrolled along the floor of the barn underneath the row of feed stations and a second strip of biodegradable paper sheet unrolled along the floor of the barn underneath the row of water supply stations where the biodegradable paper is colored with a color selected to be attractive to hatchlings, typically red.

This application is a continuation in part of application Ser. No. 15/201,562 filed Jul. 4, 2016 and currently pending.

This invention relates an improved apparatus and/or method for use in rearing hatchlings in the time period immediately after hatching and particularly to the use of a paper strip which is colored red for attracting the hatchlings.

It is one object of the invention to provide an improved apparatus and/or method for use in rearing hatchlings in the time period immediately after hatching.

According to a first aspect of the invention there is provided a method for raising chickens from hatchlings to a larger size comprising:

in a barn having a floor and walls for containing the hatchlings mounting a row of feed stations arranged at spaced positions across the floor with a feed supply line connected along the row for dispensing feed to each of the feed stations and a row of water supply stations arranged at spaced positions across the floor with a water supply line connected along the row for dispensing water to each of the water supply stations, raising the water supply stations and the row of feed stations from the floor on a lift system;

laying a plurality of parallel strips of biodegradable paper sheet material unrolled along the floor of the barn;

with the row of water supply stations and the row of feed stations raised from the floor on the lift system, applying to each of the plurality of parallel strips of biodegradable paper a layer of feed material;

wherein each of the plurality of parallel strips of biodegradable paper is colored red so as to be attractive to the hatchlings;

and when the layer of feed is at least partly depleted, operating the lift system to lower the row of water supply stations and the row of feed stations to a position at or adjacent the floor for taking of water and feed by the hatchlings, the row of water supply stations and the row of feed stations overlying one or more of the plurality of parallel strips.

Preferably the row of feed stations includes a plurality of feed supply dishes into which feed is deposited from the feed supply line and a plurality of feed drops where the feed is deposited directly onto the strip of paper.

Preferably the feed drops are shut off when the hatchlings are old and mature enough to always access the feed in the dishes.

Preferably the feed drops of the row of feed stations are located intermediate the feed supply dishes.

Preferably the row of water supply stations are arranged such that the water is deposited directly onto the strip of paper.

According to a further aspect of the invention there is provided for raising chickens from hatchlings to a larger size comprising:

in a barn having a floor and walls for containing the hatchlings mounting a row of feed stations arranged at spaced positions across the floor with a feed supply line connected along the row for dispensing feed to each of the feed stations and a row of water supply stations arranged at spaced positions across the floor with a water supply line connected along the row for dispensing water to each of the water supply stations, laying a plurality of parallel strips of biodegradable paper sheet material unrolled along the floor of the barn;

applying to each of the plurality of parallel strips of biodegradable paper a layer of feed material;

wherein each of the plurality of parallel strips of biodegradable paper is colored red on at least an upper surface so as to be attractive to the hatchlings.

Preferably the paper has a coating layer of red coloring applied to only one surface of the paper. That is, instead of coloring the paper through the thickness, a layer is applied only to one surface. In this arrangement, preferably the paper is rolled into a roll of the paper where the surface of the paper which is coated red is on the inside of the roll and the other surface is on the outside. In this way, when unrolled, the colored layer is naturally on the top of the paper facing upwardly for receiving the layer of feed.

Preferably the paper is embossed such that portions thereof are at a different height relative to other portions. That is preferably the paper is embossed with raised patches projecting upwardly in the upper or colored surface.

Preferably the coating layer of red coloring entirely covers the upper surface of the paper. However it may be applied in patches for example only at the raised portions of the embossment.

Preferably the raised patches have transverse dimensions less than 1.0 inch and preferably less than 0.5 inch.

Preferably the paper is colored red by a coating layer on the upper surface which is a water based paint. This allows the layer applied to contain a flavor/scenting material attractive to the hatchlings and also an anti-bacterial and/or disinfectant material.

In accordance with another aspect of the invention, the method includes transporting the hatchlings to the barn in a transport tray where at least an inside surface of the transport tray is colored red and the hatchlings are placed in the barn on the strips of paper which are colored red with the layer of the feed material thereon. This operation of exposing the hatchlings to the red color at a very early stage in their life customizes them to this color and makes the effect of the colored paper more effective. This occurs even though most of the paper is covered by the feed itself which is not so colored as the hatchlings expose the red color by pecking away the feed material which has been found to be particularly effective at attracting them to the paper and the feed on the paper.

According to a further aspect of the invention there is provided for raising chickens from hatchlings to a larger size comprising:

in a barn having a floor and walls for containing the hatchlings mounting a row of feed stations arranged at spaced positions across the floor with a feed supply line connected along the row for dispensing feed to each of the feed stations and a row of water supply stations arranged at spaced positions across the floor with a water supply line connected along the row for dispensing water to each of the water supply stations, transporting the hatchlings to the barn in a transport tray;

where at least an inside surface of the transport tray is colored red so as to be attractive to the hatchlings;

on the floor, laying the hatchlings on the floor so as to be supported relative to the floor by a layer of sheet material;

where at least an upper surface of the layer of sheet material is colored red so as to be attractive to the hatchlings; and

applying a layer of feed material onto the layer of sheet material on the floor.

In one embodiment, the transport tray is deposited on the floor with the hatchlings contained therein and the tray provides the layer of sheet material on which the hatchlings are supported. This method therefore does not use the paper strips but instead uses the cardboard transport tray itself as the protective sheet on which the hatchlings are laid which is then covered by the layer of feed material. The cardboard tray is then left in place and decomposes over time when the hatchlings have grown sufficiently to take feed from the feeder and water line.

In another embodiment the hatchlings are deposited from the tray onto the layer of sheet material on which the hatchlings are supported which is laid on the floor. In this case the tray is typically formed of a reusable plastics material and is removed from the barn after the hatchlings are deposited.

### BRIEF DESCRIPTION OF THE DRAWINGS

One embodiment of the invention will now be described in conjunction with the accompanying drawings in which:

FIG. 1 is a side elevational view of a prior art apparatus for dispensing a paper layer for raising hatchlings.

FIG. 2 is a top plan view of the apparatus of FIG. 1.

FIG. 3 is a longitudinal cross-sectional view of a barn showing the strip laid on the floor underneath a row of feeders.

FIG. 4 is a transverse cross-sectional view of a barn showing the strip laid on the floor underneath a row of feeders and a row of water nipples.

FIG. 5 is a top plan view of a portion only of the paper of FIGS. 1, 3 and 4

FIG. 6 is a cross-sectional view along the lines 6-6 of FIG. 5.

FIG. 7 is a cross-sectional view through a delivery tray for transporting the hatchlings to the barn of FIG. 1.

FIG. 8 is a cross-sectional view similar to that of FIG. 4 showing an alternative arrangement in which the hatchlings are laid on the floor of the barn underneath the water and feeding lines in the delivery trays.

### DETAILED DESCRIPTION

In the figures is shown an apparatus for laying a strip of sheet material 10 from a roll 11 and for depositing upon the strip 10 a layer 12 of a particulate feed material for hatchlings or chicks 13. The strip 10 is laid flat upon a floor 14 of a containment pen, the floor being formed of suitable materials well known to one killed in the art for raising birds from hatchlings.

The apparatus comprises a trailer 15 including a frame 16 and ground heels 17. The frame 16 includes frame members arranged to support a hopper 17 carried on the frame. The arrangement of the frame members will be well known to one skilled in the art so that detailed description is not required. The hopper 17 includes vertical side walls and inclined hopper bottom walls 19 and 20. The frame provides a hitch 21 at the forward end for attachment to a suitable tractor 22.

The frame 16 carries a pair of forwardly extending support walls 23 and 24 which extend forwardly from the front of the support legs 25 of the hopper. The side wall 23 and 24 are spaced by a width equal to the width of the roll 11 so that the roll is supported between the side walls on a support shaft 27. The roll is thus supported on the front of the hopper between the hopper and the tractor at a position spaced upwardly from the floor. The frame defines frame members which are spaced apart by a width greater than the width of the strip on the roll 11 so that the strip is free to fall downwardly between the frame members and between the wheels to lie upon the floor 14.

The strip is preferably formed of a biodegradable paper material which can be laid over the floor to provide a smooth support surface for receiving the feed and the hatchlings. The sheet material is of a nature which protects the hatchlings from the rough floor and supports the feed so that it is protected against being lost within the floor surface. Thus the hatchlings can be placed upon the paper or other sheet material and supported thereon in a manner which provides immediate access to the feed around them on the paper.

The hopper 17 has the side walls 19 converging inwardly and downwardly to the ends of a bottom nozzle or slot 30 extending across the width of the apparatus. The rolls 20 also converge inwardly and downwardly to define sides 31 of the nozzle.

The width of the nozzle 30 is arranged to be slightly less than the width of the sheet material. Thus as shown in FIG. 4, the layer 12 falls from the nozzle 30 onto the sheet 10 and defines ends 12A of the layer 12 which are spaced inwardly from side edges 10A of the strip material leaving a narrow band of the strip material which is free from the layer.

As the nozzle has a constant width across its full length, the layer that is discharged from the hopper is of a constant thickness, provided that the vehicle is moved across the floor at a constant speed.

Thus the arrangement has the advantage that the layer of feed material can be spread evenly across the sheet as close as possible to the edges without risk of losing feed material over the edges so that there are no bare patches on the sheet and no piles of excess feed on the sheet.

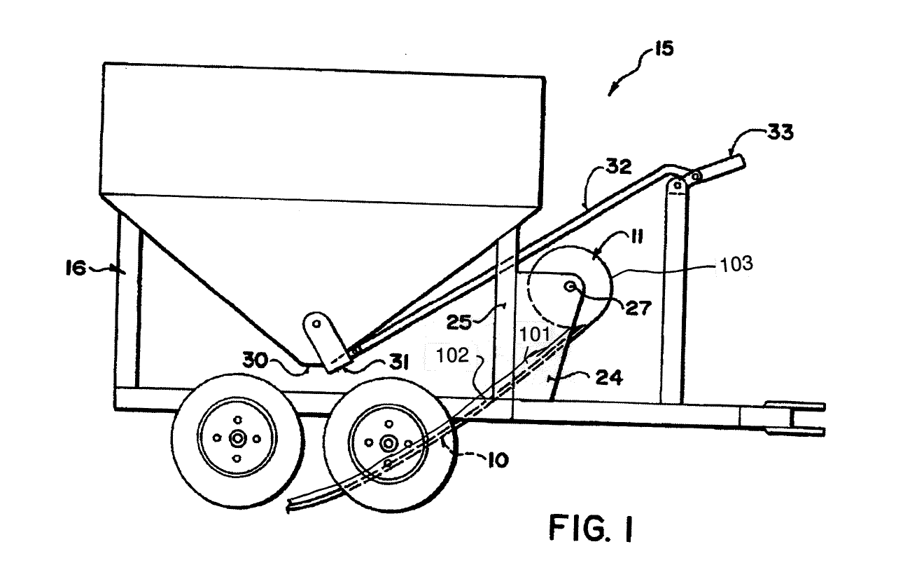

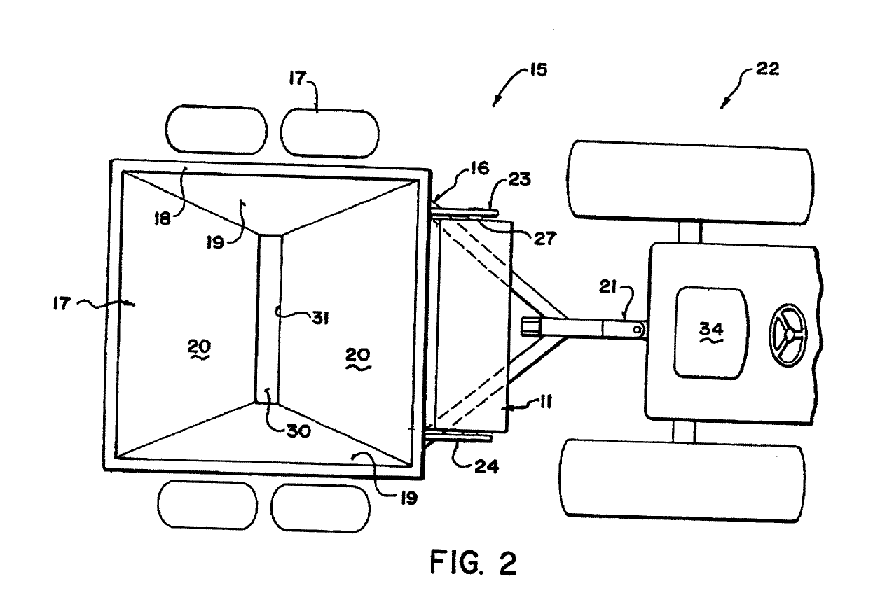

The rate of feed through the nozzle can be controlled by a closure plate 31 shown best in FIG. 1 which is operated by a link 32 movable by a lever 33 operable by an operator seated on a seat 34 of the tractor 22. Thus depending upon the flowability of the feed material in particulate form but in the hopper and depending upon the speed of movement across the floor, the operator can move the closure plate 31 to a required position to adjust the width of the slot. The closure plate is located underneath the slot or nozzle 30 so that it can be moved wholly out of the way of the nozzle allowing the full width of the nozzle to discharge the feed material or it can be moved to a position fully closing the nozzle to close off feed when not required or it can be moved to an intermediate position thus adjusting the width of the nozzle 30.

In operation, the operator grasps a portion of the strip material and pulls it underneath the hopper from the roll 11 so that the strip material is located on the floor behind the trailer 15. With the strip material so in place, the operator opens the nozzle 30 by operating the lever 33 to allow an initial portion of feed material onto the strip in the layer 12. Thus the strip is held onto the floor by the weight of the feed material and is properly located on the floor without creases, folding or slippage by the weight of the feed material as the feed material is deposited onto the strip as the vehicle is moved forwardly over the floor.

The strip is thus laid in long lengths along the length of the containment pen with the feed material spread evenly over the strip material for receiving the hatchlings 13.

In conventional manner, hatchlings can be carried manually and deposited carefully onto the feed material. The fact that the feed material is evenly spread allows the hatchlings to be dropped simply onto the paper at any position on the paper strip with the knowledge that the hatchling will be located on feed making it immediately accessible to the hatchling. Even the weakest hatchlings therefore can access feed immediately on becoming aware of their location allowing them to have access to the materials necessary for their growth thus reducing morbidity and loss.

The arrangement thus provides a roll of biodegradable paper sheet for laying along the floor of a barn onto which the hatchlings are placed arranged for raising the chickens from the hatchlings to a larger size.

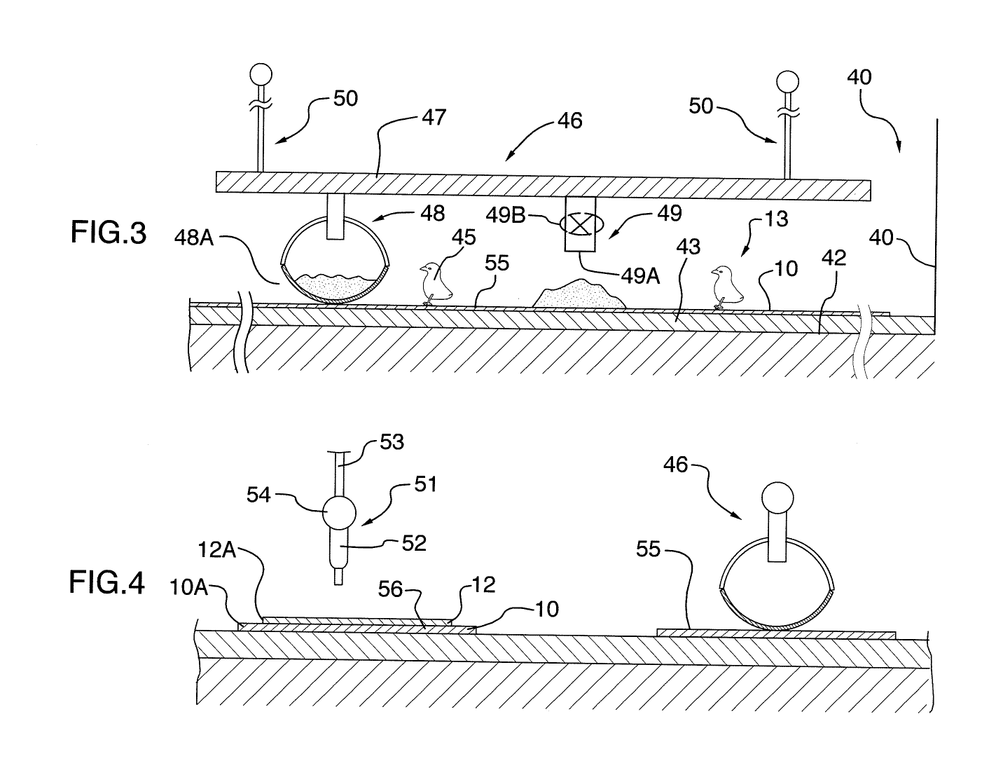

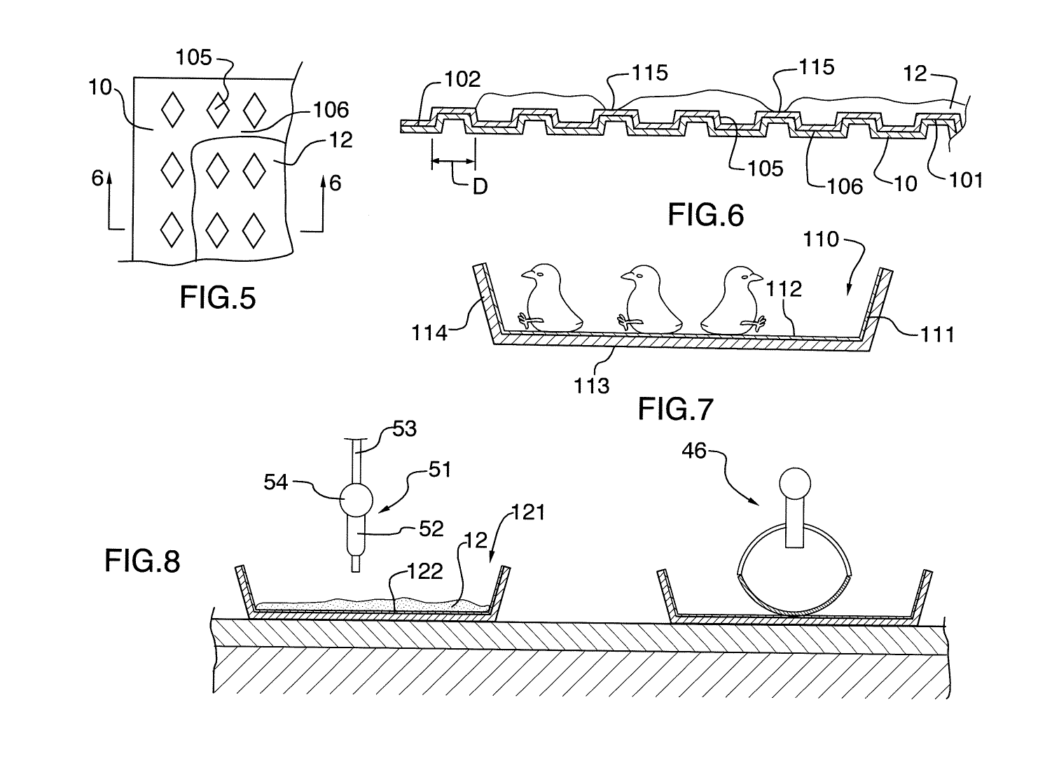

Turning now to FIGS. 3 and 4, there is shown an apparatus for raising chickens from hatchlings to a larger size including a barn 40 having a floor 42 covered by a layer 43 of straw or similar protective and absorbent material and walls 41 where the barn is closed for containing the hatchlings 45.

In the barn is provided a series of rows 46 of feed stations. The rows are arranged at spaced positions across the floor. Each row includes a feed supply line 47 connected along the row 46 for dispensing feed to each of the feed stations 48, 49. The feed stations are attached to the feed line 47 and the row of feed stations is connected to a lift system 50 for raising the feed stations from the floor to a raised position for cleaning of the floor and laying of paper while the floor is unencumbered by the feed line. There is also provided a series of rows of water supply stations 51 arranged at spaced positions across the floor and alternating with the feed lines. Each water supply row comprises a water supply line 54 connected along the row with a series of spaced water nipples 52 for dispensing water to each of the water supply stations. The row 51 of water supply stations is also connected to a lift system 53 for raising the water supply stations from the floor in a similar manner to the feed stations.

In this arrangement, the machine above is used to lay a first strip 55 of biodegradable paper sheet unrolled along the floor of the barn underneath the row of feed stations and a second strip 56 of biodegradable paper sheet unrolled along the floor of the barn underneath the row of water supply stations.

An additional strip can be laid between the rows of water and feed supply lines.

The biodegradable paper is colored with a color selected to be attractive to hatchlings. It is known that certain colors and particularly red or a color sufficiently close to red is suitable to provide attraction to the hatchlings. The specific color to be selected is any red color, but other suitable colors can be used which can be found to be more attractive to the hatchlings than the natural brown color of traditional paper or of white paper.

The row 46 of feed stations includes a plurality of feed supply dishes 48A at the stations 48 into which feed is deposited from the feed supply line and a plurality of feed drops 49A at the stations 49 where the feed is deposited directly onto the strip of paper. In this way in an initial feed supply process a feed supply member such as an auger in the line 47 is operated to drop feed both into the dishes and onto the paper. The hatchlings can take the feed from the paper until they are ready to feed from the dishes. The colored paper attracts the hatchlings to the feed line and to the water line so that they have access to the materials when otherwise they may not reach the materials and perish.

The feed drops 49 which are located intermediate the feed supply dishes 48A include a manually operable valve 49B which can be shut off when the hatchlings are old and mature enough to always access the feed in the dishes 48A.

The row of water supply stations or nipples 52 are arranged such that the water is deposited directly onto the strip of paper so that the hatchlings are attracted to the water supply again to reduce the possibility of their perishing through failure to move to the required location.

The arrangement described above thus provides a method for raising chickens from hatchlings to a larger size including the barn 40 having a floor 42 and walls 41 for containing the hatchlings. A row of feed stations 48 is arranged at spaced positions across the floor with a feed supply line 47 connected along the row for dispensing feed to each of the feed stations. A row 51 of water supply stations 52 is arranged at spaced positions across the floor 42 with a water supply line 54 connected along the row for dispensing water to each of the water supply stations.

In this method, when it is required to populate the barn with hatchlings, the water supply stations and the row of feed stations are raised from the floor 42 on a lift system 50.

As described above the cart is used for laying a plurality of parallel strips of biodegradable paper sheet material unrolled along the floor of the barn.

With the row of water supply stations and the row of feed stations raised from the floor on the lift system, the cart acts to apply to each of the plurality of parallel strips 10 of biodegradable paper a layer 12 of feed material.

As shown in FIG. 6, each of the plurality of parallel strips of biodegradable paper is colored red by a coating layer 101 so as to be attractive to the hatchlings. Thus the paper has a coating layer 101 of red coloring applied to only the top surface 102 of the paper. That is, instead of coloring the paper through the thickness, the layer 101 is applied only to one surface 102. In this arrangement, preferably the paper is rolled into a roll of the paper where the surface of the paper which is coated red is on the inside of the roll as shown in FIG. 1 and the other surface 103 is on the outside. In this way, when unrolled, the colored layer is naturally on the top of the paper 10 facing upwardly for receiving the layer 12 of the feed as dispensed by the cart.

Also during manufacture where the layer 101 is applied to the surface 102, the surface 103 of the paper is embossed by contact with an embossing roller pressed onto the surface 103 such that portions 105 thereof are pushed upwardly to a raised or a different height relative to other portions 106. That is preferably the paper is embossed with raised patches projecting upwardly in the upper or colored surface.

The coating layer 101 of red coloring entirely covers the upper surface of the paper including the raised portions 105 and the lower portions 106.

The raised patches 105 can be generally diamond shaped as shown and have transverse dimensions D less than 1.0 inch and preferably less than 0.5 inch. This dimension is selected so that the feet of the hatchlings are received on the lower portions and are restricted from sliding sideways in a splaying action by engaging the sides of the raised portions 105. The presence of the indentations or embossment in the upper surface also acts to resist the tendency of the feed layer 12 to slide off the edges of the paper.

The coating layer 101 on the upper surface is a water based paint and is mixed with other ingredients.

A first ingredient added to the coating is a flavor/scenting material so as to provide to the paper a flavor and/or scenting material attractive to the hatchlings. This enhances the attractiveness of the paper to draw the hatchlings to the paper area and the feed thereon.

Also an anti-bacterial and/or disinfectant material can be added. The disinfectant material can be of the type sold under the trade mark “Aquamaster” by Nuvac Eco-Science Inc of Valcourt Quebec. This is a product can be mixed with water or feed and taken orally by the birds or can be mixed with water and used as a disinfectant wash. The material acts as a bactericide and virus reduction material. When applied to the paper the material can reduce the development of bacteria from feces and when taken orally by the hatchlings can act internally to reduce illness and mortality.

The method further includes transporting the hatchlings to the barn in a transport tray 110 shown in FIG. 7 where at least an inside surface 111 of the transport tray is colored red by a layer 112 as described above. The whole tray may be red or the bottom surface of a next tray in the stack may also be red so that the hatchlings when contained in the stack are fully exposed to the red color. The tray has a base 113 and upstanding sides 114 to contain the hatchlings. Although not shown, the walls and base formed of a relatively stiff plastics material have stacking components which allow one tray to be stacked on the previous tray to hold the trays spaced to contain the hatchlings therebetween. Also typically when turned through 90 degrees the trays can be placed one on the next without the spacing for the hatchlings after the hatchlings are dispensed to allow the trays to be returned in a stack of reduced height. That is in this embodiment the hatchlings are dispensed from the trays onto the paper on the floor of the barn. The empty trays are then returned for the next batch of hatchlings. The hatchlings are placed in the barn on the strips of paper which are colored red with the layer of the feed material thereon. This operation of exposing the hatchlings to the red color at a very early stage while in the delivery tray customizes them to this color and makes the effect of the colored paper more effective. This occurs even though most of the red paper is covered by the feed itself which is not so colored. The hatchlings expose the red color by pecking away the feed material 12 to expose portions of the 115 of the paper between the layer of feed. This exposing of the red paper by the hatchlings pecking has been found to be particularly effective at attracting them to the paper and the feed on the paper.

In another embodiment shown in FIG. 8, the transport tray 121 is deposited on the floor with the hatchlings contained therein and the tray provides the layer of sheet material on which the hatchlings are supported. This method therefore does not use the paper strips but instead uses the base 122 cardboard transport tray itself as the protective sheet with a top covering layer 123 of the red color containing the above defined ingredients. The hatchlings remain in place in the tray and the base of the tray is then covered by the layer 12 of feed material. The cardboard tray 121 is then left in place and decomposes over time when the hatchlings have grown sufficiently to take feed from the feeder and water line.

1. A method for raising chickens from hatchlings to a larger size comprising:
in a barn having a floor and walls for containing the hatchlings mounting a row of feed stations arranged at spaced positions across the floor with a feed supply line connected along the row for dispensing feed to each of the feed stations and a row of water supply stations arranged at spaced positions across the floor with a water supply line connected along the row for dispensing water to each of the water supply stations, raising the water supply stations and the row of feed stations from the floor on a lift system;
with the row of water supply stations and the row of feed stations raised from the floor on the lift system, laying a plurality of parallel strips of biodegradable paper sheet material unrolled along the floor of the barn and applying to each of the plurality of parallel strips of biodegradable paper a covering layer of feed material which is spread evenly across the sheet close to the edges so that there are no bare patches on the sheet and so that the surface of the strip is hidden by the layer;
wherein each of the plurality of parallel strips of biodegradable paper is colored red;
and when the layer of feed is at least partly depleted by eating by the hatchlings, operating the lift system to lower the row of water supply stations and the row of feed stations to a position at or adjacent the floor for taking of water and feed by the hatchlings, the row of water supply stations and the row of feed stations overlying one or more of the plurality of parallel strips.

2. The method according to claim 1 wherein the row of feed stations includes a plurality of feed supply dishes into which feed is deposited from the feed supply line and a plurality of feed drops where the feed is deposited directly onto the strip of paper.

3. The method according to claim 2 wherein the feed drops are shut off when the hatchlings are old and mature enough to always access the feed in the dishes.

4. The method according to claim 1 wherein the feed drops of the row of feed stations are located intermediate the feed supply dishes.

5. The method according to claim 1 wherein the row of water supply stations are arranged such that the water is deposited directly onto the strip of paper.

6. A method for raising chickens from hatchlings to a larger size comprising:
in a barn having a floor and walls for containing the hatchlings mounting a row of feed stations arranged at spaced positions across the floor with a feed supply line connected along the row for dispensing feed to each of the feed stations and a row of water supply stations arranged at spaced positions across the floor with a water supply line connected along the row for dispensing water to each of the water supply stations, laying a plurality of parallel strips of biodegradable paper sheet material unrolled along the floor of the barn;
applying to each of the plurality of parallel strips of biodegradable paper a covering layer of feed material which is spread evenly across the sheet close to the edges so that there are no bare patches on the strip and so that the surface of the strip is hidden by the layer;
wherein each of the plurality of parallel strips of biodegradable paper is colored red on at least an upper surface.

7. The method according to claim 6 wherein the paper has a coating layer of red coloring applied to only one surface of the paper.

8. The method according to claim 7 wherein the paper is rolled into a roll of the paper where the surface of the paper which is coated red is on the inside of the roll and the other surface is on the outside.

9. The method according to claim 7 wherein the coating layer of red coloring entirely covers said one surface of the paper.

10. The method according to claim 6 wherein the paper is embossed such that portions thereof are at a different height relative to other portions.

11. The method according to claim 10 wherein the paper is embossed with raised patches projecting upwardly in said one surface.

12. The method according to claim 10 wherein the raised patches have transverse dimensions less than 1.0 inch and preferably less than 0.5 inch.

13. The method according to claim 6 wherein the paper is colored red by a coating layer on the upper surface which is a water based paint.

14. The method according to claim 6 wherein the paper contains a flavor/scenting material attractive to the hatchlings.

15. The method according to claim 6 wherein the paper contains an anti-bacterial and/or disinfectant material.

16. The method according to claim 6 including transporting the hatchlings to the barn in a transport tray where at least an inside surface of the transport tray is colored red so as to be attractive to the hatchlings and the hatchlings are placed in the barn on the strips of paper which are colored red with the layer of the feed material thereon.

17. A method for raising chickens from hatchlings to a larger size comprising:
in a barn having a floor and walls for containing the hatchlings mounting a row of feed stations arranged at spaced positions across the floor with a feed supply line connected along the row for dispensing feed to each of the feed stations and a row of water supply stations arranged at spaced positions across the floor with a water supply line connected along the row for dispensing water to each of the water supply stations, transporting the hatchlings to the barn in a transport tray;
where at least an inside surface of the transport tray is colored red so as to be attractive to the hatchlings;
on the floor, laying the hatchlings on the floor so as to be supported relative to the floor by a layer of sheet material;
where at least an upper surface of the layer of sheet material is colored red so as to be attractive to the hatchlings; and
applying a layer of feed material onto the layer of sheet material on the floor.

18. The method according to claim 17 wherein the transport tray is deposited on the floor with the hatchlings contained therein and the tray provides the layer of sheet material on which the hatchlings are supported.

19. The method according to claim 17 wherein the hatchlings are deposited from the tray onto the layer of sheet material on which the hatchlings are supported which is laid on the floor.
